(19) United States
(12) Patent Application Publication
(10) Pub. No.: US 2010/0029128 A1
(43) Pub. Date: Feb. 4, 2010

(54) CABLE CONNECTOR

(76) Inventors: Hiroshi TAKAHIRA, Kawasaki-shi (JP); Toshiya KIMOTO, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/473,897

(22) Filed: May 28, 2009

(30) Foreign Application Priority Data
Jul. 29, 2008 (JP) 2008-195015
Mar. 25, 2009 (JP) 2009-074235

(51) Int. Cl. H01R 13/62

(52) U.S. Cl. 439/347; 439/345

(57) ABSTRACT

Contact terminals for grounding include a fixing portion for supporting an pressing portion of an actuator member, and contact terminals for signals disposed adjacent to the contact terminals for grounding include a fixing portion shorter than the fixing portion of the contact terminal for grounding. The fixing portion is connected to one end of a movable terminal portion.

This application claims the benefit of Japanese Patent Application Nos. 2008-195015, filed Jul. 29, 2008, and 2009-074235, filed Mar. 25, 2009, which are hereby incorporated by reference herein in their entirety.

### BACKGROUND OF THE INVENTION

1. Field of the Invention

The present invention relates to a cable connector for electrically connecting one end of a cable to a wiring board.

2. Description of the Related Art

Cable connectors are made available for electrically connecting electrical components in an electronic apparatus to each other. For example, a cable connector electrically connects an electrical component to a printed wiring board through a flexible flat cable (FFC) or a flexible printed circuit (FPC). Cable connectors employing different cable fixing methods, e.g., rotary-type and slide-type connectors, are used in practice.

For example, as described in Japanese Patent Laid-Open No. 2007-042608, a rotary-type cable connector includes a connector main body which is disposed on a printed wiring board and which has a cable housing section, a plurality of contact terminals which are provided in the cable housing section of the connector main body and which electrically connect an electrode part of the printed wiring board and a terminal part of a flexible printed circuit, and an actuator member which is rotational movably supported on the connector main body to allow the terminal part of the flexible printed circuit to connect and disconnect contact portions of the contact terminals.

The connector main body has an insertion hole at one end thereof to allow the terminal part of the flexible printed circuit to be connected to pass through. The insertion hole communicates with the cable housing section formed in the connector main body. Two ends of a base end section of the actuator member are rotational movably supported in respective cutouts forming a top part of the cable housing section of the cable main body.

The actuator member is in a locked position in which the terminal part of the flexible printed circuit is sandwiched in a predetermined position by pressing surfaces of the member and a movable terminal portion of each contact terminal or in an unlocked position in which the terminal part of the flexible printed circuit is released. In the unlocked position, the actuator member keeps an attitude in which an operating part of the member is close and substantially parallel to the terminal part of the flexible printed circuit. In the unlocked position, the actuator member keeps an attitude in which the member leave the cutouts in the top part of the cable housing section open, in which the operating part is spaced from the flexible printed circuit to extend at an angle to the surface of the printed circuit having the terminal part formed thereon, and in which the member can be rotationally moved until it touches on the wall forming the periphery of the cutouts of the connector main body.

The actuator member has a pressing surface at one end of a part thereof facing the cable housing section, the pressing surface touching on a back board of the flexible printed circuit to press the back board toward the contact portions of the contact terminals which will be described later.

The plurality of contact terminals are arranged in the cable housing section in response to an array of electrodes provided at the terminal part of the flexible printed circuit. Each of the contact terminals includes a fixed terminal portion soldered to the terminal part of the printed wiring board, a stopper portion and a movable terminal portion which are formed bifurcately and which have the same length, and a connecting portion connecting the fixed terminal portion and the junction between the stopper portion and the movable terminal portion.

For example, the tip of the stopper portion of each contact terminal is disposed to face a recess on the actuator member. The movable terminal portion has a contact part at the tip thereof, the contact part being electrically connected to an electrode of the flexible printed circuit. The connecting portion is press-fitted into a slit formed adjacent to the cable housing section of the connector main body and is thereby secured to the connector main body.

In such a cable connector, the height from a surface of the printed wiring board to an uppermost end face of the connector main body tends to be at a small height, e.g., about 2 mm, because an electronic apparatus having such a cable connector disposed therein is required to have a low profile. As a result, the actuator member, which is molded from a resin, has a thickness of about 1 mm. Therefore, the actuator member is a relatively thin member.

When the cable connector is provided in a transmission path for transmitting differential signals in a relatively high frequency band, e.g., signals at a communication speed of 10 Gps or more, a reduction in the characteristic impedance with respect to a predetermined reference impedance may become a problem. In order to suppress a reduction in characteristic impedance in such a case, for example, it is suggested to configure the contact terminals such that stopper portions in response to stubs of a transmission circuit among the stopper portions and the movable portions of the terminals will be completely excluded from the connecting portions, as described in Japanese Patent Laid-Open No. 2007-123183.

### SUMMARY OF THE INVENTION

In case the contact terminals are configured such that stopper portions in response to stubs of a transmission circuit among the stopper portions and the movable portions of the terminals will be completely excluded from the connecting portions as described above in order to suppress a reduction in characteristic impedance with respect to a predetermined reference impedance value, when an end of a cable is connected to the cable connector, since the actuator member is supported at only the two ends thereof, the actuator member having a relatively small thickness as described above may warp because of a reactive force of the movable terminal portions. Further, the connecting portions of the contact terminals are press-fitted into the connector main body to a reduced depth, the solder-fixed terminal portions of the contact terminals may be delaminated from conductor patterns of the printed wiring board because of rotation moment about the connecting portions resulting from the effect of the reactive force of the movable terminal portions.

In view of the above-described problem, the present invention aims to provide a cable connector for electrically connecting one end of a cable to a wiring board. The cable connector can suppress a reduction in characteristic impedance attributable to stubs with respect to a predetermined reference impedance value and avoid a warp of an actuator member of the connector upon connecting a cable even when it is provided in a transmission path for transmitting differential signals at a communication speed corresponding to a relatively high frequency band.

To achieve the above-described object, a cable connector according to the present invention comprises a cable housing section having a contact terminal for signals and a contact terminal for grounding provided adjacent to each other in electrical connect to a terminal part of a cable, the cable housing section housing one end of the cable; and a lock/unlock member movably supported in the cable housing section, the member having a pressing portion corresponding to the contact terminal for signals and the contact terminal for grounding, the pressing portion including an pressing surface locking an electrode portion of the terminal section of the cable inserted in the cable housing section to a movable terminal portion of the contact terminal for signals and the contact terminal for grounding or unlocking the electrode portion of the terminal section to the movable terminal portion of the contact terminal, wherein the contact terminal for grounding has a fixing portion, which is continuous with the movable terminal portion thereof, for movably supporting the pressing portion of the lock/unlock member and the contact terminal for signals has a fixing portion which is continuous with the movable terminal portion thereof and which may form a stub in a signal transmission circuit, the fixing portion having a predetermined length shorter than the length of the fixing portion of the contact terminals for grounding.

In the cable connector according to the present invention, the contact terminal for signals has a fixing portion which is continuous with a movable terminal portion thereof and which may form a stub in a signal transmission circuit, and the fixing portion has a predetermined length shorter than the length of the fixing portion. Therefore, even when the connector is provided in a transmission path for transmitting differential signals at a communication speed corresponding to a relatively high frequency band, a reduction in characteristic impedance attributable to stubs in the transmission path can be suppressed with respect to a predetermined reference impedance value. Further, since the contact terminal for grounding has a fixing portion which is continuous with a movable terminal portion and which movably supports an pressing portion of the lock/unlock member, warp of the actuator member can be avoided when a cable is connected.

Further features of the present invention will become apparent from the following description of exemplary embodiments (with reference to the attached drawings).

### BRIEF DESCRIPTION OF THE DRAWINGS

FIG. 1 is a perspective view including a partial sectional view, showing major parts of an embodiment of a cable connector according to the present invention;

FIG. 2 is a perspective view including a partial sectional view, showing major parts of the embodiment of a cable connector according to the present invention;

FIG. 3 is a front view of the embodiment of a cable connector according to the present invention showing a general configuration thereof;

FIG. 4 is a plan view of the embodiment shown in FIG. 3;

FIG. 5 is a side view of the embodiment shown in FIG. 3;

Each of FIGS. 6A to 6D is a partial sectional view of the embodiment of a cable connector according to the present invention, made available for explaining an operation of the same;

Each of FIGS. 7A to 7D is a partial sectional view of the embodiment of a cable connector according to the present invention, made available for explaining an operation of the same;

FIG. 8 is a partial sectional view of another embodiment of a cable connector according to the present invention schematically showing a configuration of the same;

FIG. 9 is a perspective view of contact terminals and a slide member used in another embodiment of a cable connector according to the present invention;

FIG. 10 is a characteristic plot showing a characteristic line representing impedance characteristics of the embodiment shown in FIG. 3;

FIG. 11 is a characteristic plot showing a characteristic line representing impedance characteristics of Comparative Example 1;

FIG. 12 is a characteristic plot showing a characteristic line representing impedance characteristics of Comparative Example 2; and

FIG. 13 is a perspective view of major parts of a contact terminal array in Comparative Example 1 and Comparative Example 2.

### DESCRIPTION OF THE EMBODIMENTS

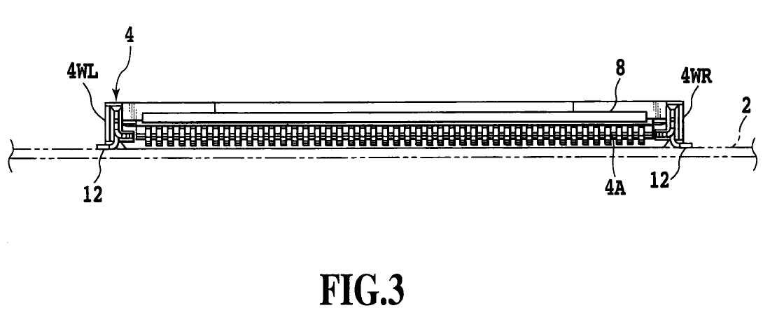

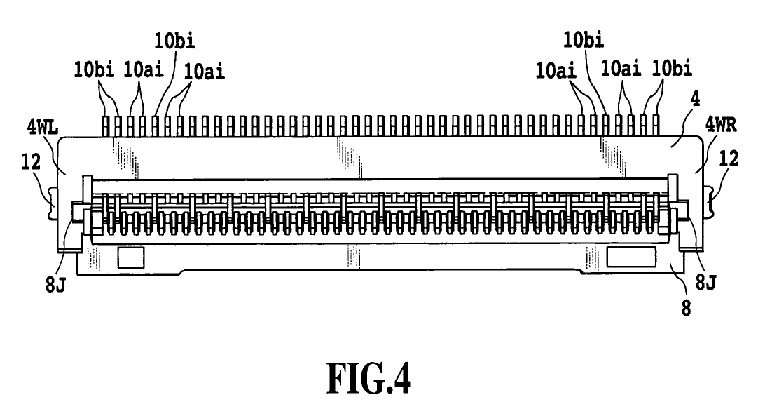

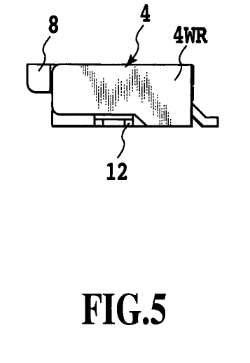

Each of FIGS. 3 and 4 shows an appearance of an embodiment of a cable connector according to the present invention.

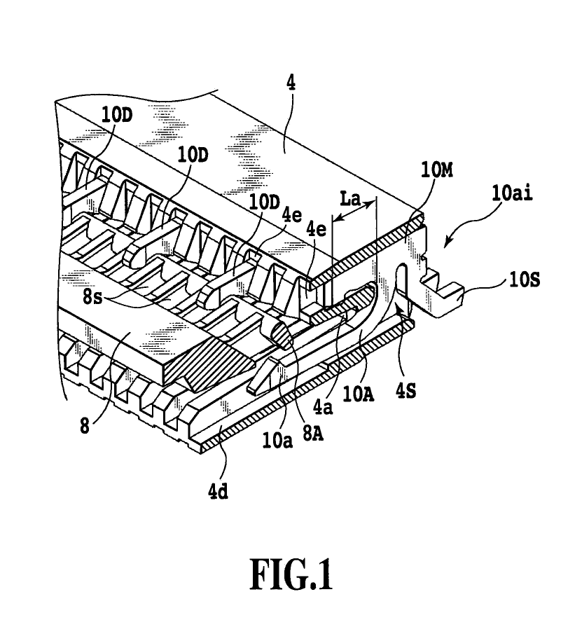

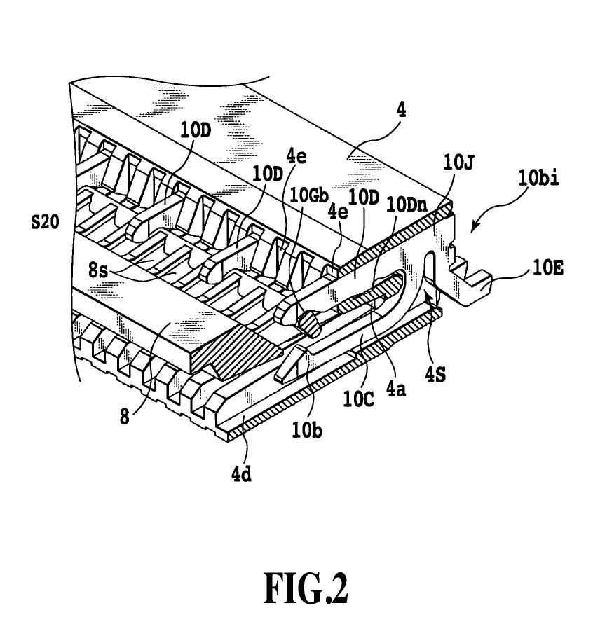

Referring to FIG. 3, the cable connector is a rotary type connector including a connector main body 4 which is disposed on a printed wiring board 2 and which has a cable housing section 4A (see FIG. 6A), a plurality of contact terminals 10ai and 10bi (i=1 to n where n is a positive integer: see FIGS. 1 and 2) which are provided in the cable housing section 4A of the connector main body 4 and which electrically connect electrode portions of the printed wiring board 2 to electrode portions of a terminal part of a flexible printed circuit 6 to be described later serving as a cable (see FIG. 6A), and an actuator member 8 which is rotational movably supported on two sidewalls 4WR and 4WL of the connector main body 4 and which secures the terminal part of the flexible printed circuit 6 to contact parts of the contact terminals 10ai and 10bi, or releases the terminal part of the flexible printed circuit 6 from contact parts of the contact terminals 10ai and 10bi.

For example, the flexible printed circuit 6 is a product called YFLEX (a registered trademark), the product configured to form a plurality of conductive layers coated with a protective layer on an insulating substrate. For example, the insulating substrate is molded to have a thickness of about 50 μm from one material appropriately selected from a group consisting of a liquid polymer (LCP), polyimide (PI), polyethylene terephthalate (PET), and polycarbonate (PC). For example, the conductive layers are layers formed from a copper alloy having a thickness of about 12 μm. For example, the protective layer is formed from a thermosetting resist layer or a polyimide film. As enlarged in FIG. 6A, a back plate 6B is provided on one surface of one end, which is a connected end, of the flexible printed circuit 6. The tabular back plate 6B is formed to have a predetermined thickness from, for example, a liquid crystal polymer (LCP) or the like similarly to the above-described insulating substrate. The back plate 6B may have an operating part for facilitating mounting and demounting of the flexible printed circuit 6.

An electrode group 6E to serve as a terminal part constituted by, for example, a plurality of electrodes having a width of 0.3 mm is provided on another surface (the surface opposite to the back plate 6B) of the end of the flexible printed circuit 6. Each pair of adjoining electrodes other is formed at an interval in the range of not less than 0.4 mm nor more than 0.6 mm to each other, e.g., an interval of about 0.5 mm. The electrode group 6E is electrically connected to a conductive layer in the flexible printed circuit 6.

The cable housing section 4A of the connector main body 4 is molded from a resin material, e.g., a liquid crystal polymer (LCP) or a heat-resistant polyamide resin (PA9T). As enlarged in FIG. 6A, the section has an opening portion 4AP at one end thereof to allow the electrode group 6E and the back plate 6B of the flexible printed circuit 6 to pass. An inner wall 4a is formed at another end of the cable housing section 4A, an end face of the back plate 6B of the flexible printed circuit 6 thus inserted touching on the inner wall to position the electrode group 6E relative to contact parts 10a of the contact terminals 10ai which are used for signals and to position the electrode group 6E relative to contact parts 10b of the contact terminals 10bi used for grounding. While the electrode group 6E is positioned relative to the contact parts 10a and 10b using the inner wall 4a in the present embodiment, the present invention is not limited to such an embodiment. For example, a separate positioning member may alternatively be formed, and the member may be provided in the cable housing section 4A.

Guide grooves (not shown) for guiding side portions of the back plate 6B of the flexible printed circuit 6 are formed on the inside of the sidewalls 4WR and 4WL which are formed at peripheral parts of the opening portion 4AP.

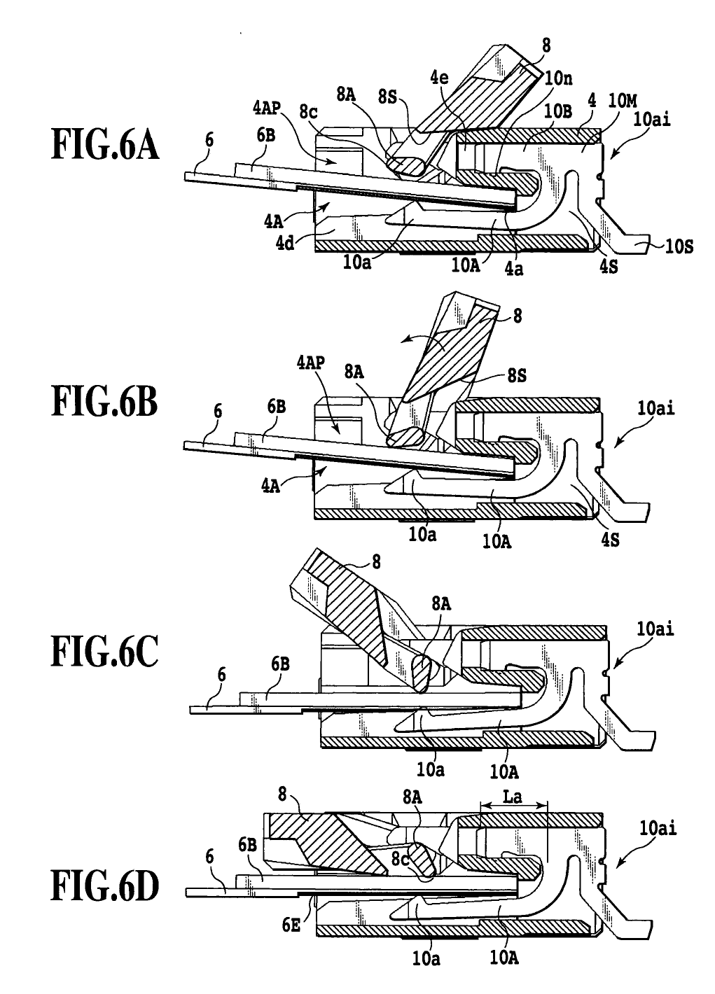

The sidewalls 4WR and 4WL are formed with respective cutouts in which support shafts 8J formed at two ends of the actuator member 8 are rotatably inserted as shown in FIG. 4. A bearing portion is formed inside each cutout to receive the respective support shaft 8J. Grooves are formed around the circumferential edges defining the cutouts. As shown in FIGS. 3 and 5, fixtures 12 for solder-fixing the connector main body 4 on the printed wiring board 2 are inserted in the grooves.

The fixtures 12 may be formed with holes in which the ends of the support shafts 8J are inserted to regulate the shafts, whereby the support shafts 8J may be rotatably held in the bearing portions.

As enlarged in FIGS. 1 and 2, a wall forming a rear section of the connector main body 4 is formed with a plurality of slits 4S into which connecting portions 10M of respective contact terminals 10ai for signals and connecting portions 10J of respective contact terminals 10bi are press-fitted. As shown in FIG. 4, except the contact terminals 10bi for grounding at both ends of the array of terminals, each pair of contact terminals 10bi for grounding adjacent to each other sandwiches two contact terminals 10ai for signals disposed adjacent and parallel to each other.

The slits 4S are arranged or formed along the longitudinal direction of the connector main body 4 at a predetermined pitch, and the slits communicate with the interior of the cable housing section 4A. A partition wall is provided between each pair of adjoining slits 4S to partition them from each other in a part thereof near the rear section of the connector main body 4. Each slit 4S branches into a slit 4e and a slit 4d at a point on its way toward the cable housing section 4A. A cutout is formed between the slits 4e and 4d, and the back plate 6B of the flexible printed circuit 6 to be connected is inserted in the cutout. The cutouts provide communication between pairs of slits 4S adjacent to each other.

Movable terminal portions 10A of the contact terminals 10ai are inserted in the slits 4d, and fixing portions 10B of the terminals are inserted in the slits 4e. Movable terminal portions 10C of the contact terminals 10bi are inserted in the slits 4d, and fixing portions 10D of the terminals are inserted in the slits 4e.

The contact terminals 10bi for grounding arranged in the cable housing section 4A corresponding to the electrode arrangement of the electrode group 6E of the flexible printed circuit 6 are configured as follows. As enlarged in FIG. 2, each of the terminals includes a solder-fixed portion 10E solder-fixed and electrically connected to an electrode pad serving as a conductive layer of the printed wiring board 2, a movable terminal portion 10C having a contact part 10b electrically connected to the electrode group 6E of the flexible printed circuit 6, a fixing portion 10D having an engaging part for rotatably supporting an pressing portion 8A of the actuator 8 which will be described later, and a connecting portion 10J for connecting a junction between one end of the movable terminal portion 10C and one end of the fixing portion 10D to the solder-fixed portion 10E.

The movable terminal portion 10C and the fixing portion 10D, which are made of sheet metal, are bifurcately formed. In a region of the fixing portion 10D facing the contact part 10b of the movable terminal portion 10C, an engaging part is formed to rotatably support an pressing portion 8A of the actuator 8 serving as a lock/unlock member as will be described later. As enlarged in FIG. 7C, the engaging part includes an arcuate part 10Gb provided at the tip of the fixing portion 10D.

As shown in FIG. 2, a nib portion 10Dn is formed between the arcuate part 10Gb of the fixing portion 10D and the part of the fixing portion 10D connected to the connecting portion 10J, the nib portion engaging the partition wall when the contact terminal 10bi is inserted.

As enlarged in FIG. 1, each contact terminal 10ai for signals includes a solder-fixed portion 10S soldered and electrically connected to an electrode pad serving as a conductive layer of the printed wiring board 2, a movable terminal portion 10A having a contact part 10a electrically connected to the electrode group 6E of the flexible printed circuit 6, a fixing portion 10B inserted in a slit 4e of the connector main body 4, and a connecting portion 10M for connecting a junction between one end of the movable terminal portion 10A and one end of the fixing portion 10B to the solder-fixed portion 10S.

The movable terminal portion 10A and the fixing portion 10B, which are made of sheet metal, are bifurcately formed. A nib portion 10n is formed at the tip of the fixing portion 10B located toward the opening portion 4AP.

The length (represented by La) from the above-described junctions to the tips of the fixing portions 10B is set at a predetermined value shorter than the overall length of the movable terminal portions 10A and the movable terminal portions 10C such that parts of the contact terminals in response to stubs of a signal transmission circuit will be minimized and such that the solder-fixed portions 10S will not be delaminated from conductor patterns on the printed wiring board 2 because of rotation moment acting around the connecting portions 10M.

The thickness of the contact terminals 10ai for signals may be the same as the thickness of the contact terminals 10bi for grounding. Preferably, the contact terminals 10ai for signals preferably have a thickness smaller than that of the contact terminals 10bi for grounding to provide the contact terminals 10ai for signals at a greater mutual distance. For example, when the mutual distance of the electrodes forming the electrode group 6E of the flexible printed circuit 6 is about 0.5 mm, the thickness of the contact terminals 10ai for signals is set within the range of not less than 0.05 mm nor more than 0.1 mm, and the thickness is preferably set at 0.1 mm. For example, when the mutual distance of the electrodes comprising the electrode group 6E of the flexible printed circuit 6 is about 0.6 mm, the thickness of the contact terminals 10ai for signals may be set within the range of not less than 0.1 mm nor more than 0.2 mm. As a result, a reduction in characteristic impedance can be more effectively suppressed as will be described later.

The thickness of the contact terminals 10bi for grounding is preferably greater than the thickness of the contact terminals 10ai for signals in order to support the actuator member 8 and a slide member 20.

Thus, even when the cable connector is provided in a signal transmission path in which differential signals are transmitted at communication speed corresponding to a relatively high frequency band, a reduction in characteristic impedance relative to a predetermined reference impedance value attributable to stubs can be suppressed, and the solder-fixed portions 10S will not be delaminated from conductor patterns on a printed wiring board 2 because of rotation moment acting round the connecting portions 10M. Further, the contact terminals 10bi for grounding allow warp of the actuator member 8 to be avoided when a cable is connected, as will be described later.

The actuator member 8 is molded of resin material, for example, such as a liquid crystal polymer (LCP), a heat-resistant polyamide resin (PA9T), or a polyphenyl sulfide resin (PPS). In an intermediate region of the member, a plurality of slits 8S are formed along the longitudinal direction of the member in a face-to-face relationship with the slits 4e of the connector main body 4. A partition wall is provided between each pair of slits 8S adjacent and parallel to each other to separate the slits. An pressing portion 8A is formed in each slit 8S so as to connect the partition walls adjacent to the slit.

The periphery of each pressing portion 8A is formed by flat surfaces which are formed opposite to each other as shown in FIG. 1, an pressing surface 8c which presses the back plate 6B of the flexible printed circuit 6 as shown in FIG. 6D when the actuator member 8 is locked, and a slide contact surface which is engaged with the arcuate part 10Gb of the contact terminal 10bi.

A support shaft 8J is formed at an end of each of shorter edges of the actuator member 8 extending orthogonal to the direction in which the slits 8S are arranged, the support shafts being rotatably supported by respective bearing portions (not shown) of the connector main body 4. The support shafts 8J are formed integrally with the actuator member 8 on one side of the shorter edges of the member so as to extend on a center axis which is shared by the pressing portions 8A. The support shafts 8J are placed on the bearing portions and rotatably inserted in the holes in the fixtures 12.

An operating part is provided on the other side of the shorter edges of the actuator member 8 so as to extend in the longitudinal direction of the actuator member 8 to connect the shorter edges.

Thus, the actuator member 8 rotatably supported by the bearing portions of the connector main body 4 assumes a locked position in which the terminal part of the flexible printed circuit 6 is sandwiched and held between the pressing surface portions 8c and the movable terminal portions 10A of the contact terminals 10ai and the movable terminal portions 10C of the contact terminals 10bi as shown in FIGS. 6D and 7D and an unlocked position in which the terminal part of the flexible printed circuit 6 is released as shown in FIGS. 6A and 7A. Specifically, in the locked position, the actuator 8 takes an attitude in which it is substantially parallel to the terminal part of the flexible printed circuit 6. In the unlocked position, the actuator member 8 takes an attitude in which the opening portion 4AP of the cable housing section 4A is exposed, in which the member extends at an angle to the surface of the flexible printed circuit 6 having the terminal part formed thereon, and in which the member can be rotated until it touches on a top surface of the connector main body 4.

In such a configuration, the electrode group 6E (back plate 6B) of the flexible printed circuit 6 is electrically connected to the contact parts 10a of the contact terminals 10ai of the contact main body 4 and the contact parts 10b of the contact terminals 10bi by inserting the flexible printed circuit 6 through the opening section 4AP until the tip of the back plate 6B touches on the inner wall 4a forming a rear part of the cable housing section 4A when the actuator member 8 is in the unlocked position as shown in FIGS. 6A and 7A. Thereafter, the operating part of the actuator member 8 is rotated counterclockwise as indicated by the arrow in FIG. 6B or in the direction of entering the locked state.

At this time, since the slide contact surfaces of the actuator member 8 thus rotated are guided by the arcuate parts 10Gb of the contact terminals 10bi by being slid in contact with the same, the pressing portions 8A are slightly moved forward until flat surfaces thereof touches on the back plate 6B.

Next, the operating portion of the actuator member 8 is further rotated in the same direction as shown in FIGS. 6C and 7C, and the pressing surface portions 8c rotate to press the back plate 6B toward the contact parts 10a and 10b. The operating portion of the actuator member 8 is further rotated into proximity to a surface of the back plate 6B as shown in FIGS. 6D and 7D. Then, since the slide contact surfaces are rotated while being supported by the arcuate portions 10Gb, the pressing surface portions 8c are further rotated from positions in which they are located directly above the contact parts 10a of the contact terminals 10ai and the contact parts 10b of the contact terminals 10bi with the back plate 6B interposed to positions closer to the inner wall 4a, the pressing surface portions being stopped at those positions. The pressing surface portions 8c touch on the back plate 6B in positions which are closer to the inner wall 4a than the relative positions of the centers of rotation of the pressing portions 8A with respect to the engaging parts of the contact terminals 10ai.

Therefore, the electrode group 6E of the flexible printed circuit 6 is pressed by the pressing surface portions 8c of the actuator member 8 to be held against the contact parts 10a of the movable terminal portions 10A of the contact terminals 10ai and the contact parts 10b of the movable terminal portions 10C of the contact terminals 10bi in electrical contact therewith. Thus, the back plate 6B of the flexible printed circuit 6 is sandwiched between the pressing surface portions 8c of the actuator member 8 and the movable terminal portions 10A of the contact terminals 10ai and the movable terminal portions 10C of the contact terminals 10bi which are elastically displaced. At this time, the centers of rotation of the pressing portions 8A are located in positions directly above the contact parts 10a of the contact terminals 10ai and the contact parts 10b of the contact terminals 10bi, and points of application of the pressing surface portions 8c are located closer to the inner wall 4a than the contact parts 10a and 10b are. Thus, even when a tensile force or bending moment acts on the other end of the flexible printed circuit 6, the actuator member 8 will not be rotated clockwise. Therefore, the end of the flexible printed circuit 6 will not come off the cable connector.

Further, the positions of the centers of rotation of the pressing section 8A relative to the engaging parts of the fixing portions 10D of the contact terminals 10ai move in a predetermined course toward the rotated positions of same relative to the engaging parts. Thus, the opening angle of the actuator member 8 can be set relatively large.

To remove the flexible printed circuit 6 in the state shown in FIGS. 6D and 7D from the connector main body 4, the operating section of the actuator member 8 is moved the clockwise direction that is opposite to the counterclockwise direction indicated by the arrows in FIGS. 6B and 7B or the direction of entering the unlocked state. At this time, the slide contact surfaces of the rotating actuator member 8 are rotated about the arcuate parts 10Gb of the contact terminals 10ai. Thereafter, and the pressing surface portions 8c leave the back plate 6B, and the slide contact surfaces are guided by inclined surfaces of the fixing portions 10D by being slid in contact therewith. Then, an inclined surface of the actuator member 8 is made to touch on a top surface of the connector main body 4. Thus, the flat surfaces of the pressing portions 8A are slightly moved into proximity to the back plate 6B while being rotated. Thus, the degree of opening of the actuator member 8 is greater than those in similar apparatus in the related art.

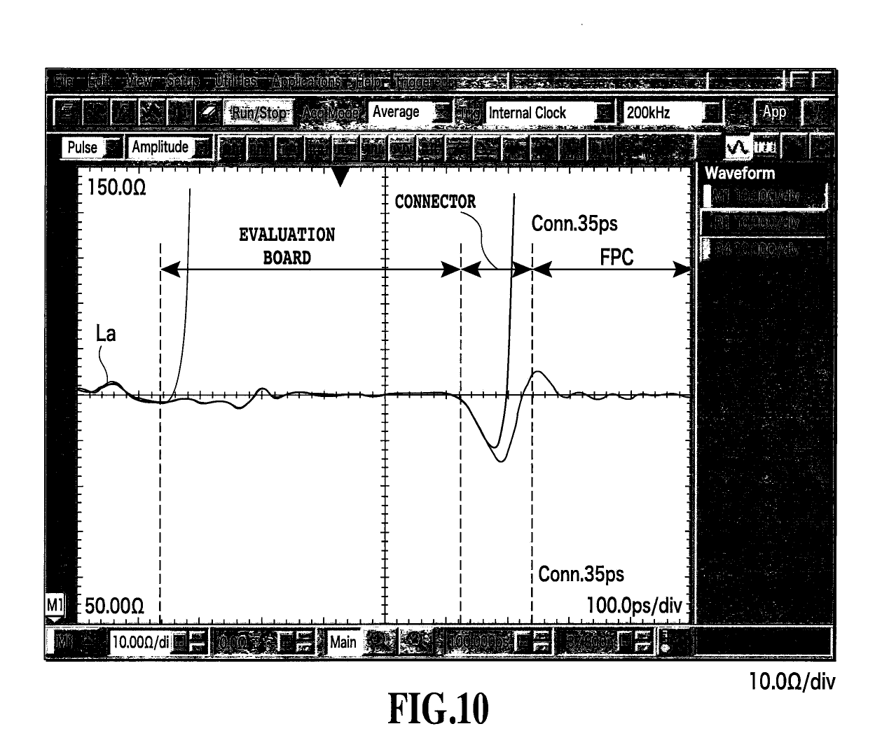

High frequency characteristics of the embodiment of the cable connector shown in FIG. 3 were verified by the inventor. FIG. 10 show results of a test carried out using a predetermined characteristic impedance measuring apparatus (DSA8200TDR manufactured by Tektronix Inc.). FIG. 10 shows a characteristic line La displayed on a display section of the apparatus. The characteristic line La represents changes in the characteristic impedance of a transmission path as a rise time Tr is set at 35 ps where resistance values (K) plotted along a vertical axis on the display section; time is represented by a horizontal axis.

The measurement was carried out by applying a predetermined step signal to a predetermined transmission path including the cable connector as a sample for measurement and observing a reflection waveform of the signal using the characteristic impedance measuring apparatus with the rise time Tr (ps) of the signal set at each of 35 ps, 70 ps, and 200 ps. Step signals having rise times Tr of 35 ps, 70 ps, and 200 ps correspond to 10 GHz, 5 GHz, and 1.75 GHz, respectively.

The above described sample for measurement is a cable connector which is connected to one end of a flexible printed circuit (FPC) 6 having a predetermined length and which is disposed on a predetermined evaluation board. Another end of the flexible printed circuit (FPC) 6 is open. The evaluation board has a signal input/output section which is connected to the characteristic impedance measuring apparatus. When the mutual distance of electrodes forming an electrode group 6E of the flexible printed circuit 6 is set at about 0.5 mm, each of the contact terminals 10ai for signals and contact terminals 10bi for grounding of the cable connector disposed in response to the electrodes is set at a thickness of about 0.1 mm.

As apparent from FIG. 10, the region of the transmission path corresponding to the cable connector had maximum and minimum impedance values of 105Ω and 85Ω, respectively. When the rise time (Tr) was 70 ps, the region of the transmission path corresponding to the cable connector had maximum and minimum impedance values of 102Ω and 91Ω, respectively. Further, when the rise time (Tr) was 200 ps, the region of the transmission path corresponding to the cable connector had maximum and minimum impedance values of 98Ω and 96Ω, respectively. It was therefore confirmed that the cable connector allows a reduction in characteristic impedance to be suppressed, for example, with reference to an impedance value of 100Ω even when the connector is disposed in a transmission path of a relatively high frequency band.

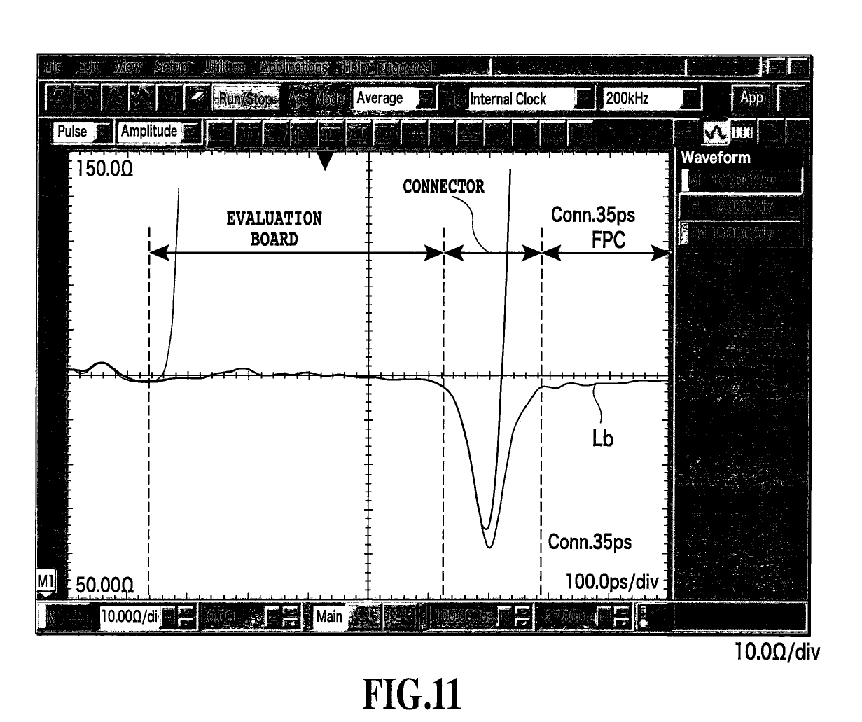

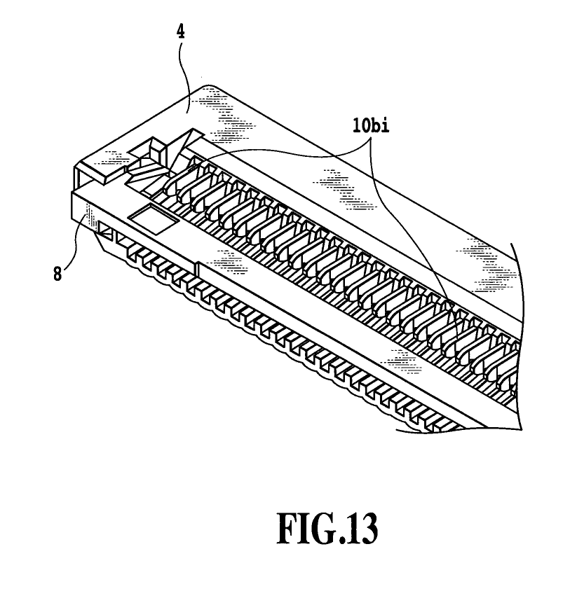

FIG. 11 shows a characteristic line Lb as a result of a test carried out on Comparative Example 1 using the predetermined characteristic impedance measuring apparatus (DSA8200TDR manufactured by Tektronix Inc.). The sample for measurement used in Comparative Example 1 is a connector cable which is connected to one end of a flexible printed circuit (FPC) having a predetermined length and which is disposed on a predetermined evaluation board. Another end of the flexible printed circuit (FPC) is open. When the mutual distance of electrodes comprising an electrode group 6E of the flexible printed circuit 6 is set at about 0.5 mm, the contact terminals for signals and contact terminals for grounding of the cable connector disposed in response to the electrodes have the same shape each other as shown in FIG. 13. Therefore, the connector has contact terminals for signals and contact terminals for grounding having the same shape as the above-described contact terminals 10bi for grounding having a thickness of 0.1 mm. In FIG. 13, elements identical to those in the embodiment shown in FIG. 3 are indicated by like reference numerals to avoid duplicated description.

As apparent from FIG. 11, the region of the transmission path corresponding to the cable connector had maximum and minimum impedance values of 98Ω and 61Ω, respectively, when the signal had a rise time (Tr) of 35 ps. When the rise time (Tr) was 70 ps, the region of the transmission path corresponding to the cable connector had maximum and minimum impedance values of 98Ω and 73Ω, respectively. Further, when the rise time (Tr) was 200 ps, the region of the transmission path corresponding to the cable connector had maximum and minimum impedance values of 98Ω and 87Ω, respectively. It was therefore confirmed that Comparative Example 1 resulted in greater reductions in characteristic impedance compared to the embodiment of the present invention.

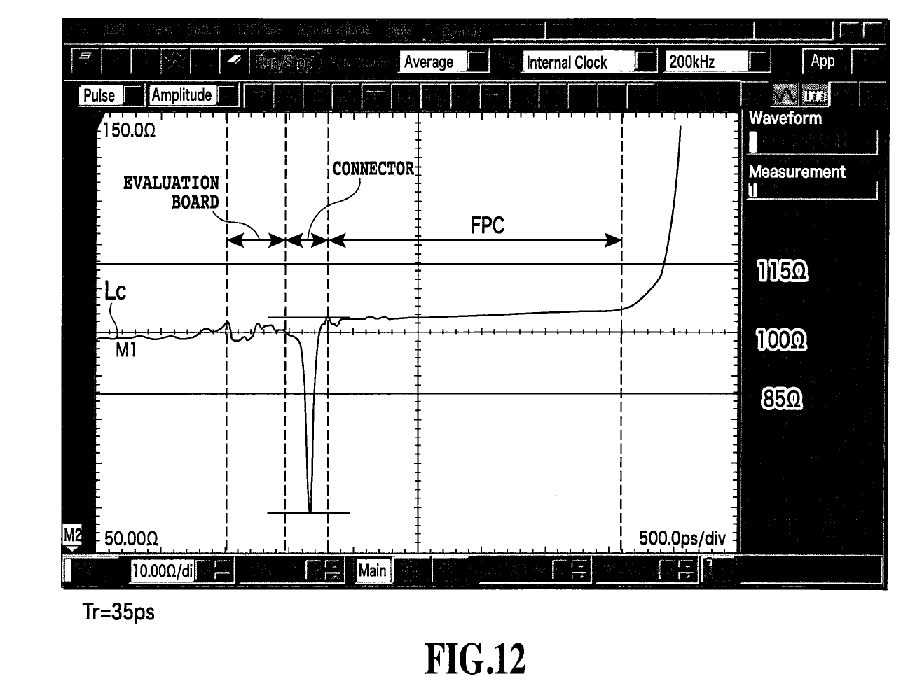

FIG. 12 shows a characteristic line Lc as a result of a test carried out on Comparative Example 2 using the predetermined characteristic impedance measuring apparatus (DSA8200TDR manufactured by Tektronix Inc.). The sample for measurement used in Comparative Example 2 is a connector cable which is connected to one end of a flexible printed circuit (FPC) having a predetermined length and which is disposed on a predetermined evaluation board. Another end of the flexible printed circuit (FPC) is open. When the pitch of electrodes comprising an electrode group 6E of the flexible printed circuit 6 is set at about 0.5 mm, the contact terminals for signals and contact terminals for grounding of the cable connector disposed in association with the electrodes have the same shape each other as shown in FIG. 13 and therefore have a thickness of 0.2 mm. Thus, the connector has contact terminals for signals and contact terminals for grounding having the same shape as the above-described contact terminals 10bi.

As apparent from FIG. 12, the region of the transmission path corresponding to the cable connector had maximum and minimum impedance values of 104Ω and 59Ω, respectively, when the signal had a rise time (Tr) of 35 ps. When the rise time (Tr) was 70 ps, the region of the transmission path corresponding to the cable connector had maximum and minimum impedance values of 104Ω and 73Ω, respectively. It was therefore confirmed that Comparative Example 2 resulted in greater reductions in characteristic impedance compared to Comparative Example 1. Therefore, it was confirmed that decrease of the contact terminal thickness is effective for suppressing the reduction in characteristic impedance.

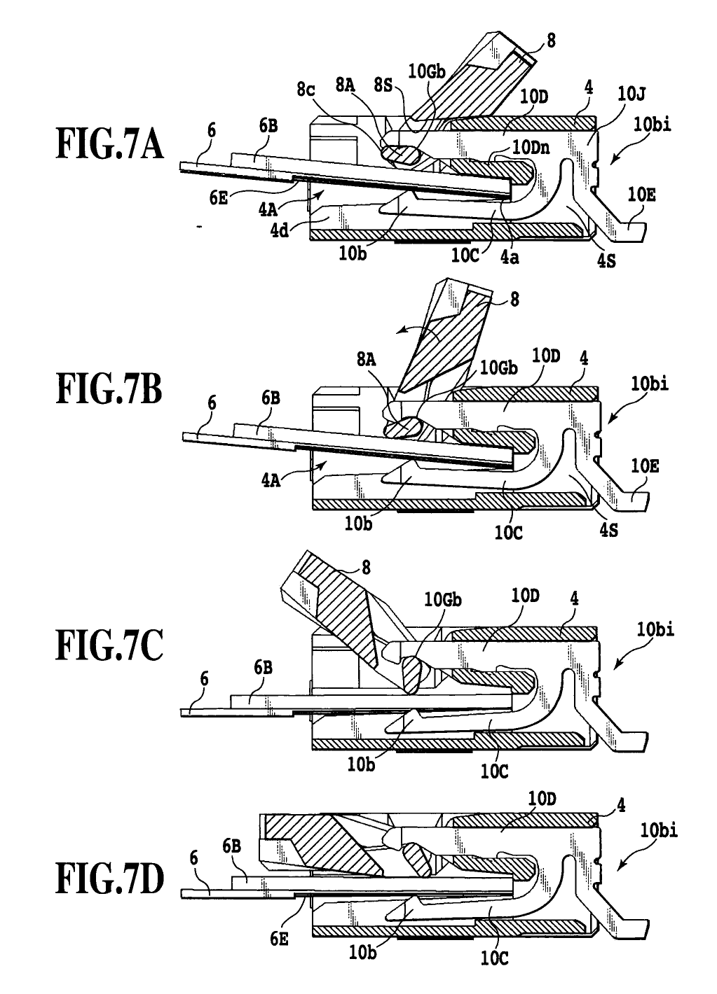

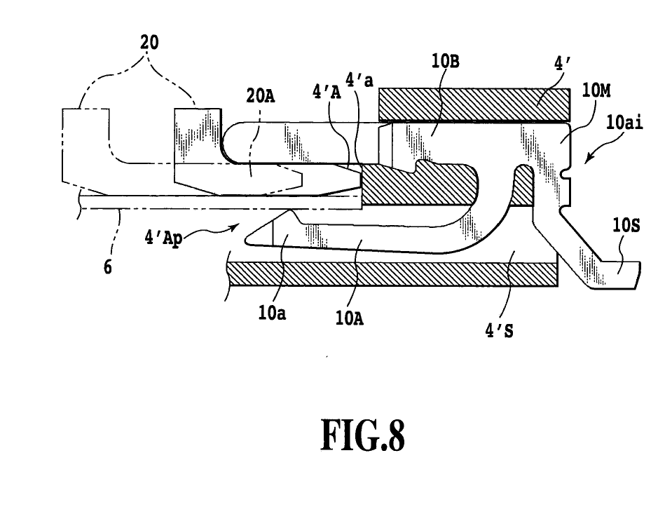

FIG. 8 shows major parts of another embodiment of a cable connector according to the present invention.

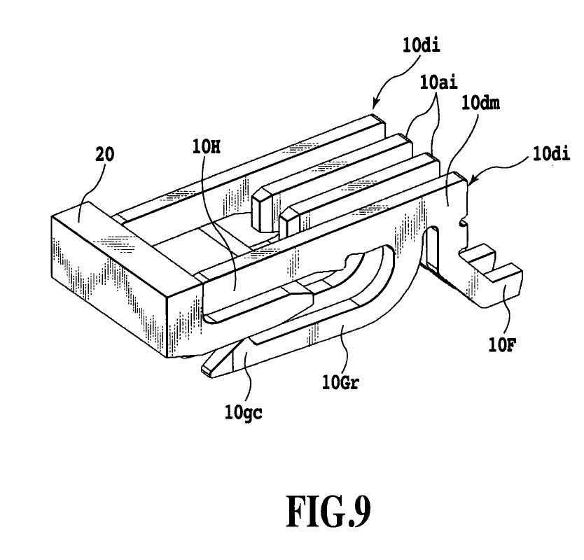

The embodiment shown in FIG. 1 is a rotary type, whereas the embodiment shown in FIG. 8 is a slide type cable connector. In FIGS. 8 and 9, elements identical to elements of the embodiment shown in FIG. 1 are indicated by like reference numerals to omit duplicated description.

The cable connector includes a connector main body 4′ which is disposed on a printed wiring board 2 and which has a cable housing section 4′A, a plurality of contact terminals 10ai for signals and contact terminals 10di for grounding (i=1 to n where n is a positive integer) which are provided in the cable housing section 4′A of the connector main body 4′ and which electrically connect electrode portions of the printed wiring board 2 to electrode portions of a terminal part of a flexible printed circuit 6 serving as a cable, and a slide member 20 which is slidably supported in guide grooves (not shown) formed in the cable housing section 4′A of the connector main body 4′ and which serves as a lock/unlock member for securing the terminal part of the flexible printed circuit 6 to contact parts of the contact terminals 10ai for signals and the contact terminals 10di for grounding or releasing the terminal part of the flexible printed circuit 6 from contact parts of the contact terminals 10ai for signals and the contact terminals 10di for grounding.

The cable housing section 4′A of the connector main body 4′ which is molded from, e.g., a resin has an opening portion 4′AP at one end thereof to allow an electrode group 6E and a back plate 6B of the flexible printed circuit 6 to pass through. An inner wall 4va is formed at another end of the cable housing section 4′A, such that an end face of the back plate 6B of the flexible printed circuit 6 inserted touches on the inner wall to position the electrode group 6E relative to contact parts 10a of the contact terminals 10ai for signals and to position the electrode group 6E relative to contact parts 10gc of the contact terminals 10di for grounding.

Guide grooves (not shown) for guiding side portions of the back plate 6B of the flexible printed circuit 6 are formed on the inside of two sidewalls which are formed at peripheral parts of an opening portion 4′AP.

In a wall forming a rear section of the connector main body 4′, are formed a plurality of slits 4′S into which connecting portions 10M of respective contact terminals 10ai for signals and connecting portions 10dm of respective contact terminals 10di are press-fitted. Except the contact terminals 10di for grounding at both ends of the array of terminals, each pair of contact terminals 10di for grounding adjacent to each other sandwiches two contact terminals 10ai for signals disposed adjacent and parallel to each other.

The contact terminals 10di for grounding arranged in the cable housing section 4′A corresponding to the electrode arrangement of the electrode group 6E of the flexible printed circuit 6 are configured as follows. As enlarged in FIG. 9, each of the terminals 10di includes a solder-fixed portion 10F soldered and electrically connected to an electrode pad serving as a conductive layer of the printed wiring board 2, a movable terminal portion 10Gr having a contact part 10gc electrically connected to the electrode group 6E of the flexible printed circuit 6, a fixing portion 10H inserted in a slit 4′ S of the connector main body 4′ for slidably supporting a pressing portion 20A of the slide member 20, and a connecting portion 10dm for connecting a junction between one end of the movable terminal portion 10Gr and one end of the fixing portion 10H to the solder-fixed portion 10F. The movable terminal portion 10Gr and the fixing portion 10H, which are made of sheet metal, are bifurcately formed.

In such a configuration, on the occasion of connecting electrically the electrode group 6E (back plate 6B) of the flexible printed circuit 6 to the contact parts 10a of the contact terminals 10ai of the contact main body 4′ and the contact parts 10gc of the contact terminals 10di, the tip of the back plate 6B of the flexible printed circuit 6 is inserted through the opening section 4′AP until the tip of the back plate 6B touches on the inner wall 4′ a forming a rear part of the cable housing section 4′A when first, the slide member 20 is in an unlocked position represented by a chain double-dashed line in FIG. 8. Then, the pressing portions 20A of the slide member 20 are pushed into the cable housing section 4′A as represented by a solid line in FIG. 8. Thus, the electrode group 6E of the flexible printed circuit 6 is pressed and held against the contact parts 10a of the movable terminal portions 10A of the contact terminals 10ai and the contact parts 10gc of the movable terminal portions 10Gr of the contact terminals 10di by pressing surface portions of the pressing portions 20A of the slide member 20 to be electrically connected to the contact parts. Thus, the back plate 6B of the flexible printed circuit 6 is sandwiched between the pressing surface portions of the slide member 20 and the movable terminal portions 10A of the contact terminals 10ai and the movable terminal portions 10Gr of the contact terminals 10di which are elastically displaced.

On the occasion of removing the flexible printed circuit 6 from the connector main body 4′, the pressing portions 20A of the slide member 20 are slid in the direction of moving away from the connector main body 4′ or in the direction of entering an unlocked state. Thus, the back plate 6B of the flexible printed circuit 6 becomes removable from the connector main body 4′.

Therefore, such an embodiment is also advantageous in that a reduction in characteristic impedance attributable to stubs can be suppressed with respect to a predetermined reference impedance value even when the cable connector is provided in a signal transmission path for transmitting differential signals at a communication speed corresponding to a relatively high frequency band and in that the solder-fixed portions 10F can not delaminate conductor patterns on the printed wiring board 2 because of rotation moment acting about the connecting portions 10M. Further, the contact terminals 10di for grounding allow the slide member to be prevented from warping when the cable is connected.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A cable connector comprising:
a cable housing section having a contact terminal for signals and a contact terminal for grounding provided adjacent to each other in electrical connect to a terminal part of a cable, said cable housing section housing one end of the cable; and
a lock/unlock member movably supported in said cable housing section, said lock/unlock member having a pressing portion corresponding to the contact terminal for signals and the contact terminal for grounding, the pressing portion including an pressing surface locking an electrode portion of the terminal section of the cable inserted in said cable housing section to a movable terminal portion of the contact terminal for signals and the contact terminal for grounding or unlocking the electrode portion of the terminal section to the movable terminal portion of the contact terminal, wherein
the contact terminal for grounding has a fixing portion, which is continuous with the movable terminal portion thereof, for movably supporting the pressing portion of said lock/unlock member and the contact terminal for signals has a fixing portion which is continuous with the movable terminal portion thereof and which may form a stub in a signal transmission circuit, the fixing portion having a predetermined length shorter than the length of the fixing portion of the contact terminals for grounding.

2. A cable connector according to claim 1, wherein said lock/unlock member is an actuator member rotational movably disposed in said cable housing section.

3. A cable connector according to claim 1, wherein the lock/unlock member is a slide member slidably disposed in said cable housing section.

4. A cable connector according to claim 1, wherein the thickness of the contact terminals for signals is smaller than the thickness of the contact terminals for grounding.

5. A cable connector according to claim 1, wherein the mutual distance of the electrodes comprising the terminal part of the cable is set in the range of not less than 0.4 mm nor more than 0.5 mm.

6. A cable connector according to claim 1, wherein the thickness of the contact terminals for signals, which are in the form of plates, is set in the range of not less than 0.05 mm nor more than 0.1 mm when the mutual distance of the electrodes comprising the terminal part of the cable is set at 0.5 mm.

7. A cable connector according to claim 1, wherein the thickness of the contact terminals for signals, which are in the form of plates, is set in the range of not less than 0.1 mm nor more than 0.2 mm when the mutual distance of the electrodes comprising the terminal part of the cable is set at 0.6 mm.
